(19) United States
(12) Patent Application Publication
(10) Pub. No.: US 2018/0258567 A1
(43) Pub. Date: Sep. 13, 2018

(54) Needle Loom

(71) Applicant: Oskar Dilo Maschinenfabrik KG, Eberbach (DE)

(72) Inventor: Johann Philipp Dilo, Eberbach (DE)

(73) Assignee: Oskar Dilo Maschinenfabrik KG, Eberbach (DE)

(21) Appl. No.: 15/906,248

(22) Filed: Feb. 27, 2018

(30) Foreign Application Priority Data
Mar. 9, 2017 (EP) 17 160 090.1

(51) Int. Cl. D04H 18/02; F16H 21/44

(52) U.S. Cl. CPC D04H 18/02; F16H 21/44

(57) ABSTRACT

A needle loom for needling a nonwoven web which includes a needle beam arrangement with at least one needle beam and a drive device for moving the needle beam arrangement back and forth in a punching direction. The drive device has a first drive and a first main shaft. A first main conrod connects the main shaft to the needle beam arrangement in articulated fashion and is supported eccentrically on the first main shaft. The first drive is actuated in such a way that it moves the first main shaft cyclically back and forth around a predetermined rotational angle.

### CROSS REFERENCE TO RELATED APPLICATION

This application claims priority based on European Patent Application No. EP 17 160 090.1, filed Mar. 9, 2017, the contents of which are incorporated by reference in its entirety.

### FIELD OF THE INVENTION

The invention relates to a needle loom, and more specifically, a needle loom for needling a nonwoven web.

### BACKGROUND OF THE INVENTION

Needle looms are generally known to the skilled person and are described in, for example, Lünenschloβ and Albrecht: “Vliesstoffe” (Nonwovens), Georg-Thieme-Verlag, Stuttgart, 1982, pp. 122-129.

In needle looms, a nonwoven web is usually fed to the inlet side of the needle loom and conveyed in the web-conveying direction to a needling zone. In the area of the needling zone, at least one needle beam is arranged. A needle board, which is equipped with needles for consolidating the nonwoven, is attached to the needle beam. In this area, the nonwoven to be needled is usually guided between a stripper plate and a punching plate. To consolidate the nonwoven, the needles are pushed in a punching direction into the nonwoven and pulled back out again at high frequency. The needles pass through openings in the stripper plate and in the punching plate. The product thus being formed is a consolidated nonwoven. The person skilled in the art is familiar with a wide variety of forms of needle looms, including double needle looms, in which needling is performed from above and from below by two needle beams, and needle looms in which the needle beam is moved along with the nonwoven web in the conveying direction of the web during the consolidation process.

So that the needles arranged on the needle beam can be punched into the nonwoven web and pulled back out again, needle looms comprise a drive device, which causes the needle beam to execute a stroke in the punching direction. Such drive devices comprise, for example, two main shafts, on each of which a main conrod is eccentrically supported, so that a rotational movement of the main shaft is converted by the main conrod into a stroke movement of the needle beam in the punching direction. The main shafts can be coupled to each other by a spur gear stage and preferably turn in opposite rotational directions. This makes it possible to neutralize the forces acting transversely to the punching direction, which can be caused by the eccentric movement of the main conrod. Because the two main shafts are coupled by a gear stage, it is sufficient for only one of the main shafts to be driven in rotation by a drive.

Needle looms in which the needle beam is to be moved along in the conveying direction of the nonwoven web during the consolidation process usually also comprise a secondary drive. This secondary drive comprises at least one secondary shaft, on which a secondary conrod is eccentrically supported. The secondary conrod extends substantially parallel to the conveying direction of the nonwoven web and is connected to the needle beam in articulated fashion. As a result of the eccentric mounting of the conrod on the secondary shaft, a rotational movement of the secondary shaft is converted by the secondary conrod into a stroke movement of the needle beam in the conveying direction of the nonwoven web. The secondary shaft is conventionally also driven in rotation by a drive. As a result of the superimposition of the stroke movement of the needle beam in the punching direction on the stroke movement of the needle beam in the conveying direction of the nonwoven web, the needle beam is moved around an substantially elliptical path. Needle looms of this type are known from, for example, EP 0 892 102 A.

It is desirable to have the ability to adapt both the stroke of the needle beam in the punching direction and the stroke of the needle beam in the conveying direction of the nonwoven web to the requirements in the individual case, e.g., the requirements associated with the transport speed, the thickness of the nonwoven web, the material of the web, and the density of the nonwoven web.

### OBJECTS OF THE INVENTION

It is an object of the present invention to provide a needle loom for needling a nonwoven web in which the stroke of the needle beam in the punching direction and/or the stroke of the needle beam in the conveying direction of the nonwoven web can be adjusted in a needle loom with the simplest possible mechanical and kinematic configuration. This object is achieved by the device disclosed herein.

### SUMMARY OF THE INVENTION

According to a first aspect of the invention, a needle loom for needling a nonwoven web comprises a needle beam arrangement with at least one needle beam and also comprises a drive device for moving the needle beam arrangement back and forth in a punching direction. The drive device comprises a first drive and a first main shaft, wherein a first main conrod is eccentrically supported on the first main shaft and connects the first main shaft to the needle beam arrangement in articulated fashion. The first drive is actuated in such a way that it moves the first main shaft cyclically back and forth around a predetermined first rotational angle. This means that the rotational direction of the main shaft is reversed at a first and a second reversal point.

In this way the stroke of the needle beam arrangement in the punching direction can be easily adjusted by the control unit of the needle loom or of the first drive. Thus a needle loom with adjustable stroke is created without complicated mechanisms, as a result of which a low-cost realization is possible. The stroke of the needle beam arrangement in the punching direction is defined by the size of the first rotational angle and its position with respect to the rotational axis of the first main shaft. The rotational angle in turn can be easily adjusted by the user by way of the control unit. The stroke of the needle beam arrangement in the punching direction can be adjusted in various ways. First, it is possible to change the size of the first rotational angle around which the first main shaft is moved cyclically back and forth. In general, a larger rotational angle has the effect of producing a longer stroke. Another possibility of adjusting the stroke consists in changing the position of the first rotational angle with respect to the rotational axis of the first main shaft. If this rotational angle is arranged between the top dead center and the bottom dead center of the movement of the main conrod, then, for the same value of the first rotational angle, the length of the stroke in the punching direction will be longer than when the first rotational angle is arranged symmetrically to the top dead center or bottom dead center. Any desired intermediate positions and sizes of the rotational angle are conceivable. The stroke of the needle beam arrangement in the punching direction can thus be changed in any way desired and adapted to the given requirements. No complicated mechanisms or complicated kinematics are necessary. Instead, the stroke of the needle beam arrangement in the punching direction can be adjusted simply by controlling the first drive, which transmits a corresponding alternating rotational movement to the first main shaft. It thus becomes possible to adjust the stroke of the needle beam arrangement in the punching direction of a needle loom easily and at low cost.

The punching direction is substantially perpendicular to the conveying direction of the nonwoven web. For the conventional setup of a needle loom, the punching direction is thus substantially vertical.

The first rotational angle is preferably in the range of 2-178°, more preferably in the range of 10-90°. These angle ranges have an especially advantageous effect on the needling process. In general, larger rotational angles produce a longer stroke of the needle beam arrangement but mean at the same time that greater torque is required to drive the main shaft. Smaller rotational angles, conversely, produce a shorter stroke of the needle beam arrangement but can be accomplished with less torque on the shaft. It is obvious that the first rotational angle can be adapted by the person skilled in the art in any way desired to the existing requirements, so that in particular both smaller and larger angles can be used.

In a preferred embodiment, the drive device also comprises a second drive and a second main shaft, wherein a second main conrod is eccentrically supported on the second main shaft. The second conrod connects the second main shaft to the needle beam arrangement in articulated fashion. The second drive is actuated in such a way that it moves the second main shaft cyclically back and forth around a predetermined second rotational angle, wherein the second rotational angle is preferably in the range of 2-178°, even more preferably in the range of 10-90°.

The provision of a second main shaft and of a second main conrod offers the advantage that the loads which act on the shaft-conrod combination and their drive are reduced. If separate drives are provided on the first and second main shafts, the torque to be provided by each drive is also reduced. In this way, smaller drives can be used, or the rotational speeds of the drives can be increased. The independent driving of the first and second main shafts offers the particular advantage that the first and second rotational angles can be adjusted independently of each other. This offers the user a large number of possible ways to influence the movement of the needle beam arrangement. The advantages described above in association with the size of the first rotational angle apply also to the preferred size range for the second rotational angle.

In one embodiment, the first drive and the second drive are actuated in such a way that the first rotational angle is equal to the second rotational angle, and the first and the second main shafts are moved in phase to achieve a uniform stroke movement of the main conrods and of the needle beam arrangement.

It is preferred that the first drive and the second drive be actuated in such a way that they move the first and second main shafts back and forth in opposite directions. This makes it possible to neutralize the forces, acting in the conveying direction of the nonwoven web, caused by the rotational movement of the main shafts and of the main conrods. In particular, this measure has the effect of reducing undesirable vibrations of the drive device and of the needle loom.

In an alternative embodiment, the first drive and the second drive are actuated in such a way that the first and second main shafts are moved with a phase offset. The time at which the first main conrod reaches its maximum or minimum stroke or at which the first main shaft reverses direction is consequently different from the time at which the second main conrod reaches its maximum or minimum stroke or the second main shaft reverses direction.

In addition or alternatively, in another embodiment, the first drive and the second drive are actuated in such a way that the first rotational angle is not equal to the second rotational angle. The maximum stroke achievable by the first main conrod is therefore different from the maximum stroke achievable by the second main conrod. As a result of these two possibilities, the needle beam arrangement can be tilted relative to the plane of the nonwoven web, that is, tilted in or opposite to the conveying direction. In this way, the time when the needles at the leading edge of the needle board enter the nonwoven web is different from the time when the needles at the trailing edge of the needle board enter the nonwoven web.

The first drive and/or the second drive preferably comprises an electric motor, more preferably a torque or servo motor. These types of motors are especially good for producing rotational movements with cyclically changing rotational direction. Above all, they make possible the highly dynamic back-and-forth movements of the main shafts, which are characterized by a high-frequency alternation between rotational directions. A preferred frequency is in the range of 1,500-3,000 strokes/minute.

In an especially preferred embodiment, the needle loom also comprises a secondary drive device for moving the needle beam arrangement in a conveying direction of the nonwoven web, transverse to the punching direction. The secondary drive device comprises a secondary drive and a secondary shaft, wherein a secondary conrod, which connects the secondary shaft to the needle beam arrangement in articulated fashion, is eccentrically supported on the secondary shaft. The secondary drive is actuated in such a way that it moves the secondary shaft cyclically back and forth around a predetermined third rotational angle. As a result, it is possible additionally to adapt the stroke of the needle beam arrangement in the conveying direction of the nonwoven web advantageously to the given requirements. This embodiment also offers the advantage that there is no need for any complicated mechanisms to adjust the stroke in the conveying direction.

In another aspect of the invention, the needle loom for needling a nonwoven web comprises a needle beam arrangement with at least one needle beam, a drive device for moving the needle beam arrangement back and forth in a punching direction, and a secondary drive device for moving the needle beam arrangement in a web-conveying direction which is transverse to the punching direction. The drive device comprises a first drive and a first main shaft, wherein a first main conrod, which connects the main shaft to the needle beam arrangement in articulated fashion, is eccentrically supported on the first main shaft. The secondary drive device comprises a secondary drive and a secondary shaft, wherein a secondary conrod, which connects the secondary shaft to the needle beam arrangement in articulated fashion, is eccentrically supported on the secondary shaft. The secondary drive is actuated in such a way that it moves the secondary shaft cyclically back and forth around a predetermined rotational angle.

In this way, the stroke of the needle beam arrangement in the conveying direction of the nonwoven web can be easily adjusted by the control unit of the needle loom, i.e., by control of the secondary drive. A needle loom with adjustable stroke without complicated mechanisms is thus created, as a result of which the needle loom can be realized at low cost. The stroke of the needle beam arrangement in the conveying direction of the nonwoven can thus be easily and quickly adapted to the given requirements, in particular to the conveying speed, thickness, and material of the nonwoven web. The stroke of the needle beam arrangement in the conveying direction is defined by the size of the predetermined rotational angle and its position relative to the rotational axis of the secondary shaft. The rotational angle in turn can be easily adjusted by the user by way of the control unit. The stroke of the needle beam arrangement in the conveying direction can be adjusted in various ways. The use of a secondary shaft moving cyclically back and forth offers in particular the advantage that the stroke in the conveying direction can be easily adjusted. In addition, the kinematics of the needle engagement can be optimized in any way desired by the user through the influence which can be exerted on the difference between the speed of the needles and the speed of the nonwoven web.

The rotational angle of the secondary shaft is preferably continuously variable, so that it can be adjusted in any way desired.

The rotational angle is preferably in the range of 2-178°, more preferably in the range of 10-150°. The advantages described above with respect to the size of the first rotational angle also apply to the preferred size range for the rotational angle of the secondary shaft.

The first drive in this embodiment is preferably actuated in such a way that it moves the first main shaft in continuous rotation. It is also possible to provide a second main shaft, which is appropriately coupled by means of, for example, a spur gear stage, to the first main shaft, and which is usually made to rotate in the direction opposite to that of the first main shaft.

The secondary drive preferably comprises an electric motor, preferably a torque or servo motor, which is especially well adapted to the production of rotational movements with cyclically changing rotational directions. Above all, they also make it possible to produce the highly dynamic back-and-forth movements of the secondary shaft, which are characterized by high-frequency changes of rotational direction. A preferred frequency is in the range of 1,500-3,000 strokes/minute.

### BRIEF DESCRIPTION OF THE DRAWINGS

The drawings illustrate a preferred embodiment including the above-noted characteristics and features of the device. The device will be readily understood from the descriptions and drawings. In the drawings:

FIG. 1 shows a perspective schematic diagram of an embodiment of a needle loom according to the invention;

FIGS. 2a-2e show schematic front views of the needle loom according to FIG. 1 at different points of a movement cycle;

FIG. 3a shows a perspective schematic diagram of an alternative embodiment of a needle loom according to the invention;

FIG. 3b shows a schematic front view of the needle loom according to FIG. 3a;

FIG. 4a shows a perspective schematic diagram of another alternative embodiment of a needle loom according to the invention;

FIG. 4b shows a front view of the needle loom according to FIG. 4a; and

FIGS. 5a-5b show schematically the relationships between the angular position of a shaft or of a conrod and the stroke of the needle beam arrangement.

### DETAILED DESCRIPTION OF THE EMBODIMENTS

The figures show only the components of a needle loom which are essential to the description of the invention. For the sake of clarity, for example, the machine housing, the nonwoven web, the stripper plate, and the punching plate are omitted, since the way in which they are arranged is familiar to the person skilled in the art.

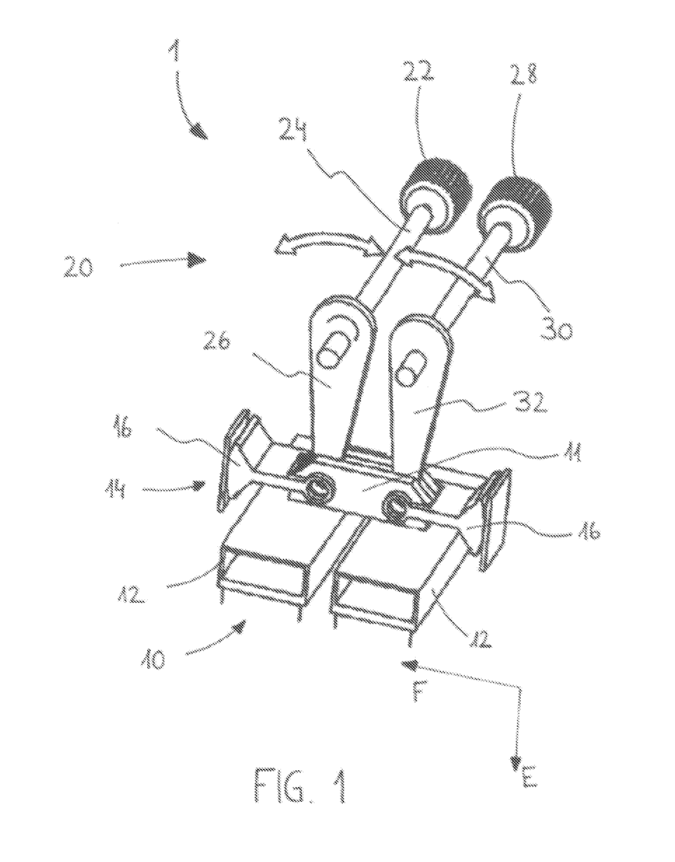

FIG. 1 shows schematically a perspective view of part of an embodiment of a needle loom 1 according to the invention. The needle loom 1 comprises a needle beam arrangement 10 and a drive device 20. Needle beam arrangement 10 comprises at least one needle beam 12. In the embodiment shown here, two needle beams 12 are provided, which are fastened to a needle beam support 11, by which they are carried. By way of example, needle boards with only one needle at each edge are shown, these needles projecting from the side of needle beam 12 facing away from drive device 20. It is obvious that, in an actual realization of a needle loom 1 according to the invention, a plurality of needles or needle rows will be arranged on the bottom of each needle board.

In the embodiment shown here, a vertical guide 14 is provided, which comprises two roller levers 16. Roller levers 16 have an articulated connection to needle beam support 11 and roll along opposing surfaces of the machine housing in the known manner. By use of vertical guide 14, needle beam arrangement 10 is substantially fixed in position in the conveying direction of the nonwoven web, which is indicated by the arrow F in FIG. 1. In the exemplary embodiment described here, the punching direction of the needles into the nonwoven web, indicated in FIG. 1 by the arrow E, is oriented vertically. It is obvious that, under certain conditions, a deviation from the precisely vertical orientation is also possible.

Drive device 20 moves needle beam arrangement 10 back and forth in the punching direction E. This corresponds normally to a vertical stroke movement of needle beam 12. Drive device 20 comprises at least a first drive 22, a first main shaft 24, and a first main conrod 26. In the preferred embodiment shown, drive device 20 also comprises a second drive 28, a second main shaft 30, and a second main conrod 32. First main conrod 26 and second main conrod 32 are each connected in articulated fashion to needle beam arrangement 10 and, preferably fastened to needle beam support 11. First main conrod 26 has an articulated connection at the end facing away from needle beam arrangement 10 to first shaft 24, whereas second main conrod 32 has an articulated connection at the end facing away from needle beam arrangement 10 to second main shaft 30. First and second main conrods 26, 32 are connected to first and second main shafts 24, 30 in such a way that a rotational movement of main shafts 24, 30 is converted into a substantially linear movement of needle beam arrangement 10. An eccentric connection of main conrods 26, 32 to main shafts 24, 30 is especially well adapted to this purpose as the eye of each conrod is supported rotatably on an eccentric section of the associated shaft.

In contrast to known needle looms, in which the main shafts are driven in continuous rotation, first main shaft 24 and second main shaft 30 are each moved back and forth around a predetermined rotational angle. This cyclic back-and-forth movement is indicated in FIG. 1 by the two curved double arrows above main shafts 24, 30. To produce this cyclic back-and-forth movement of first and second main shafts 24, 30, first drive 22 and second drive 28 are actuated in such a way that they reverse the rotational direction of the associated main shaft 24, 30 in cyclic fashion. A control unit (not shown) supplies first and second drives 22, 28 with the size and direction of the first and second rotational angles relative to the associated rotational axes and also specifies the rotational speed. The rotational angles around which first main shaft 24 and second main shaft 30 move cyclically back and forth are preferably individually and continuously variable.

Electric motors are especially suitable as drives 22, 28. Torque or servo motors are particularly well adapted to the task of driving the main shafts in rotation and of implementing the necessary number of changes of direction and the number of strokes. It is obvious that the specifications of the drives depend substantially on the torques to be applied. A frequency of 1,500-3,000 strokes per minute should preferably be realizable. The number of changes of the rotational directions of main shafts 24, 30 required for this depends also on the orientation of the rotational movement relative to the rotational axis of the associated shaft, as will be described in greater detail below. If it should prove necessary, it is also possible to provide more than one drive per main shaft 24, 30. This depends in particular on the torque to be applied and the power requirement. In addition to the direct connection between first drive 22 and first main shaft 24 or second drive 28 and second main shaft 30, it is also conceivable that drives 22, 28 are coupled indirectly, e.g., by means of a traction drive with a toothed belt, to corresponding main shaft 24, 30.

It is obvious that the principle of the invention is also applicable when only one drive, one main shaft, and one main conrod are provided. In addition, it is conceivable that more than two drives, two main shafts, and two main conrods could be used, wherein the kinematics will be correspondingly more complex. By way of example, furthermore, two needle beams 12 are provided in FIG. 1. It is also obvious here that, depending on the existing requirements, only one or any other desired number of needle beams 12 can be used.

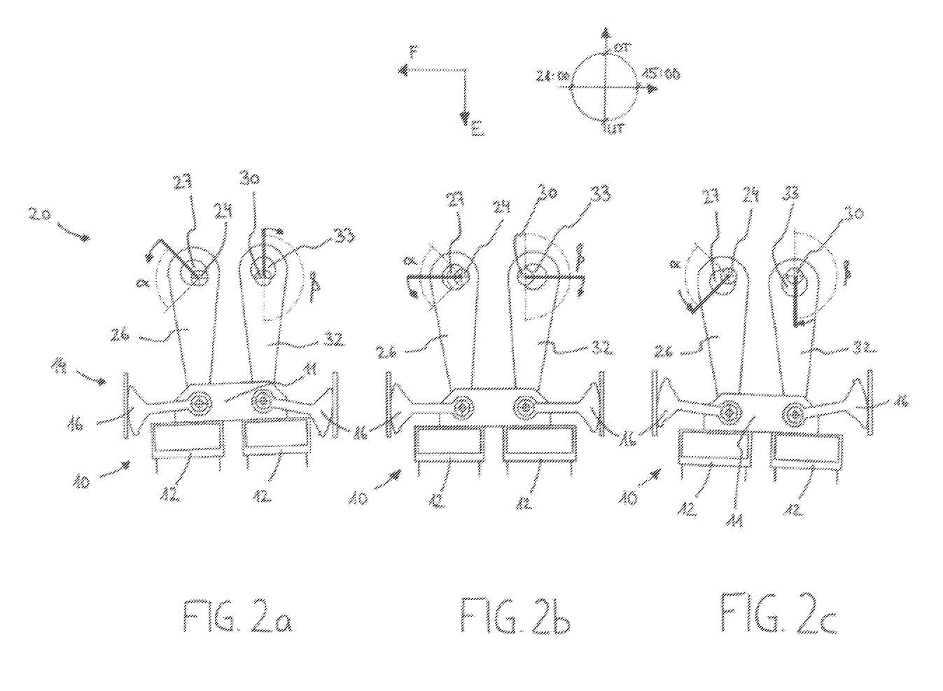

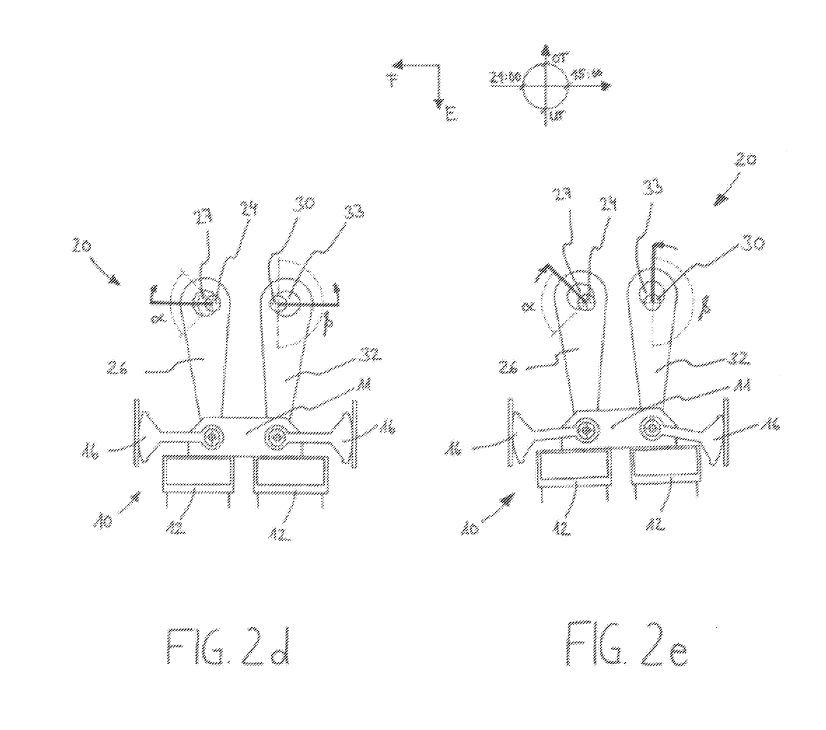

FIGS. 2a-2e show by way of example schematic diagrams of a complete movement cycle of needle loom 1 as executed by the embodiment described on the basis of FIG. 1. To describe the movement cycle, a global coordinate system is used, which is applicable to all the figures and which is characterized by the conveying direction F of the nonwoven web and punching direction E. In addition, a local coordinate system applicable to all the figures is introduced, which serves to describe the position of a conrod or of the associated shaft. In the case of a continuous rotational movement of a shaft or of a conrod, the center axis of the conrod eye connected to the shaft forms a circular path around the rotational axis of the associated shaft. According to the general theory of eccentric shaft/conrod arrangements, a top dead center (OT) and a bottom dead center (UT) are defined, at which the center points of the two conrod eyes of a conrod lie on a straight line with the center point of the associated shaft. Correspondingly, a 15:00 o'clock position and a 21:00 o'clock position are defined symmetrically between the top dead center and the bottom dead center. It is obvious that any intermediate position corresponding to the hand of a clock can be specified. This local coordinate system has its origin in each case on the center axis of the shaft on which the conrod is eccentrically supported.

In the embodiment shown in FIG. 2, the top dead center and the bottom dead center of first and second main conrods 26, 32 are located correspondingly on an axis parallel to the punching direction E. The 15:00 o'clock position and the 21:00 o'clock position are located on an axis parallel to the conveying direction F. To illustrate the angle position of first and second main conrods 26, 32, i.e., of associated conrod eyes 27, 33 in FIGS. 2a-2e, a ray is also drawn, which connects the center point of main shaft 24, 30 in question to the associated center point of conrod eye 27, 33. During a movement cycle, the ray travels around a predetermined rotational angle, wherein the direction in which each of the shaft-conrod arrangements moves is characterized by an arrow on the associated ray.

The movement cycle according to FIGS. 2a-2e proceeds between an upper position of needle beam arrangement 10 (FIGS. 2a and 2e) and a lower position of needle beam arrangement 10 (FIG. 2c), wherein intermediate positions are shown in FIGS. 2b and 2d. In the embodiment shown here, first main shaft 24 is moved cyclically back and forth around a predetermined first rotational angle α, and second main shaft 30 is moved cyclically back and forth around a predetermined second rotational angle β. In this example, the first rotational angle α is different from second rotational angle β. The two rotational angles α, β are in this case symmetric to an axis parallel to conveying direction F. More precisely, the first rotational angle α and thus the movement of first main conrod 26 are symmetric to the 9 o'clock position of first main shaft 24, and second rotational angle β and the position of second main conrod 32 are symmetric to the 3 o'clock position of second main shaft 30. Because rotational angles α and β are different, second main conrod 32, when in the starting position shown in FIG. 2a, is higher (in the present case at the top dead center) than first main conrod 26. Needle beam support 11, has articulated connections to first and second main conrods 26, 32, resulting in a tilted arrangement relative to conveying direction F. It can be seen that first main shaft 24 and second main shaft 30 are moved in opposite directions; that is, initially first main shaft 24 is moved in the clockwise direction and second main shaft 30 in the clockwise direction.

In the starting position shown in FIG. 2a, first main conrod 26 and second main conrod 32 are each located at their upper reversal point. In this starting position, needle beam arrangement 10 has not yet executed a stroke in punching direction E. First main shaft 24 and second main shaft 30 are now moved in opposite directions, so that needle beam arrangement 10 performs a stroke in punching direction E.

FIG. 2b shows an intermediate position, in which first main conrod 26 is in the 21:00 o'clock position and second main conrod 32 is in the 15:00 o'clock position. Because of the symmetric arrangement of first and second rotational angles α, β to these positions, first main conrod 26 and second main conrod 32 and thus, needle beam arrangement 10 have been moved by a distance equal to half a stroke in punching direction E. The conrods preferably pass continuously through the intermediate positions shown in FIG. 2b.

FIG. 2c show first main conrod 26, second main conrod 32, and needle beam arrangement 10 in a lower position. First main shaft 24 and first main conrod 26 are at a lower reversal point, in which the ray formed between the axis of first main shaft 24 and the axis of conrod eye 27 lies at the edge of first rotational angle α. Second main shaft 30 and second main conrod 32 are also located at a lower reversal point, in which the ray formed between the axis of second main shaft 30 and the axis of conrod eye 33 lies on the edge of second rotational angle β. In these positions, first main conrod 26 and second main conrod 32 and thus, needle beam 10 have executed the maximum stroke in punching direction E. Because of the difference between rotational angles α and β, needle beam arrangement 10 is also tilted in this position relative to conveying direction F. At least in this lower position according to FIG. 2c, the needles of needle beam 12 are engaged with the nonwoven web to be needled. At the lower reversal point of first and second main conrods 26, 32 and of needle beam arrangement 10, the rotational movement of first and second main shafts 24, 30 reverses direction.

As can be seen in FIG. 2d and as indicated by the two curved arrows on the rays illustrating the rotational movement, first main shaft 24 is now moving in the clockwise direction, and second main shaft is moving in the counterclockwise direction. These movements proceed beyond the intermediate positions shown in FIG. 2d and result in a return to the starting positions shown in FIG. 2e. The position in FIG. 2e corresponds to the starting position according to FIG. 2a, so that a new movement cycle can begin by a new reversal of the rotational direction of first and second main shafts 24, 30.

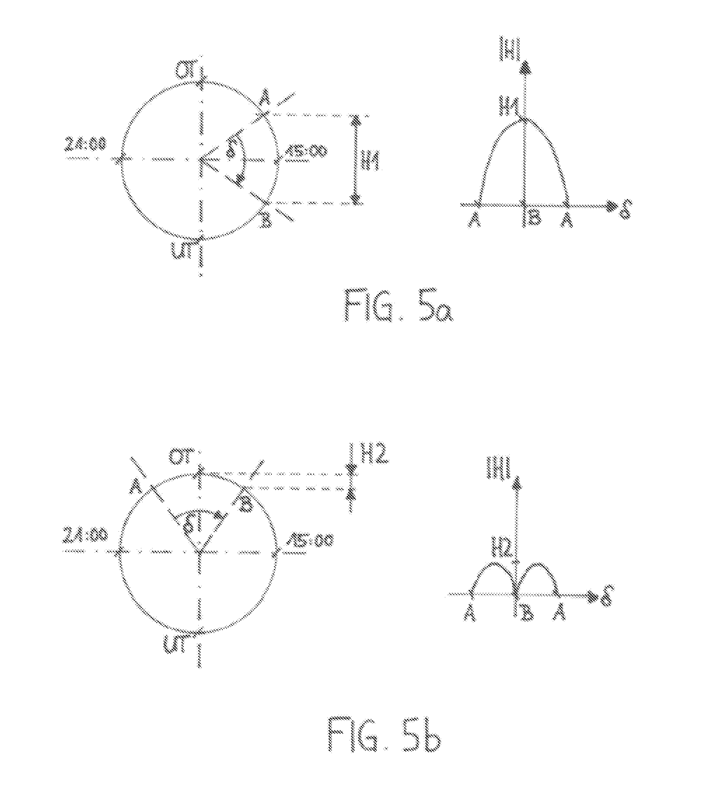

If a tilting of needle beam arrangement 10 is not desired, first rotational angle α, for example, can be made equal to second rotational angle β, wherein two rotational angles α, β are to be arranged in the same position relative to the associated axes of main shafts 24, 30. It can also be seen that the sizes of first and second rotational angles α, β substantially determine the lengths of the strokes in punching direction E. Additional relationships between the rotational angle and the stroke can be derived from FIG. 5 and from the associated description.

In the case illustrated here, first main shaft 24 and second main shaft 30 move in phase. This means that in each case the upper reversal point and the lower reversal point and thus also the points of minimum and maximum stroke are reached simultaneously. Corresponding second main shaft 30 due to the larger rotational angle must be moved at a faster speed than first main shaft 24.

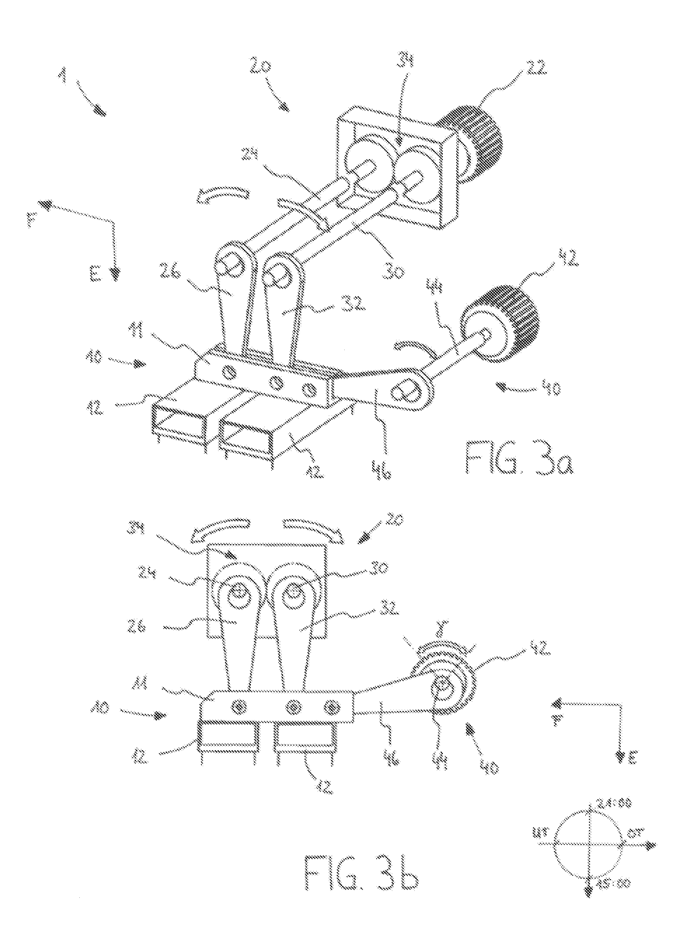

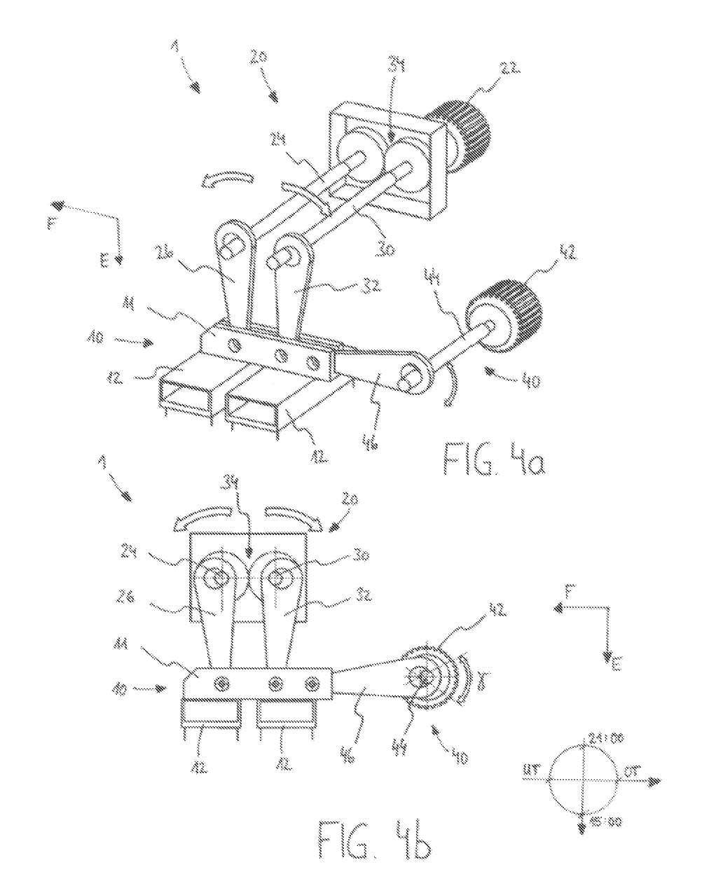

FIGS. 3 and 4 show two alternative embodiments of a needle loom 1 according to the invention. The essential difference versus the needle loom 1 of FIGS. 1 and 2 is that needle loom 1 according to FIGS. 3 and 4 comprises a secondary drive device 40. Secondary drive device 40 serves to move needle beam arrangement 10 in conveying F of the nonwoven web. In the case of a conventional setup of a needle loom, this corresponds to a horizontal movement of needle beam arrangement 10. Therefore, secondary drive device 40 brings about a horizontal stroke of needle beam arrangement 10, i.e., a stroke of needle beam arrangement 10 transverse to punching direction E.

Secondary drive device 40 comprises a secondary drive 42, a secondary shaft 44, and a secondary conrod 46, which is supported eccentrically on secondary shaft 44 and connects the shaft to needle beam arrangement 10 in articulated fashion. In the embodiment shown, only one drive, e.g., first drive 22, is provided to drive first and second main shafts 24, 30. Two main shafts 24, 30 are in this case connected to each other by a gear mechanism, preferably a spur gear stage 34. Spur gear stage 34 is preferably configured in such a way that first main shaft 24 and second main shaft 30 move in opposite directions, as indicated by the two curved arrows above the associated shafts. In the embodiment shown here, furthermore, first main shaft 24 and second main shaft 30 are driven in continuous rotation.

Secondary drive 42 is actuated in such a way that it moves secondary shaft 44 cyclically back and forth around a predetermined rotational angle. The cyclic back-and-forth movement of secondary shaft 44 is indicated in FIGS. 3 and 4 by a curved double arrow above and next to secondary shaft 44. The cyclical back-and-forth movement is achieved by the reversal of the rotational direction of secondary shaft 44 at two reversal points, between which the determined rotational angle of secondary shaft 44 is defined. Secondary drive 42 can drive secondary shaft 44 directly or can be connected to it by a gear mechanism, such as a traction transmission with a toothed belt.

Secondary drive device 40 forces needle beam arrangement 10 to execute a movement component in conveying direction F of the nonwoven web. This movement component is superimposed on the movement component of needle beam arrangement 10 in punching direction E, which is imposed on needle beam arrangement 10 by drive device 20. As a function of the stroke in punching direction E and of the stroke in conveying direction F and the superimposition of the two movement components in time, needle beam arrangement 10 is moved along a more-or-less elliptical path.

The speed of needle beam arrangement 10 in conveying direction F preferably corresponds to the conveying speed of the nonwoven web while the needles of needle beam 12 are engaged in the nonwoven web. In this way, time delay within the nonwoven web can be suppressed, and the transverse forces which act on the needles and which arise from the relative speed between the nonwoven web and the needles are reduced.

In alternative embodiment, it is conceivable that, in addition to secondary shaft 44, first and second main shafts 24, 30 could also be moved cyclically back and forth. With respect to a cyclical movement of first and second main shafts 24, 30, see the description of FIGS. 1 and 2. If there is only one main shaft, this single shaft can also be moved cyclically back and forth.

As can be derived from FIGS. 3b and 4b, the indicated local coordinate system is rotated by 90° relative to that according to FIGS. 2a-2e to correspond to the orientation of the stroke movement of secondary conrod 46. More precisely, the local coordinate system is rotated in such a way that the top dead center (OT) and the bottom dead center (UT) lie on an axis parallel to conveying direction F. Correspondingly, the 15:00 o'clock position and the 21:00 o'clock position of secondary conrod 46 relative to secondary shaft 44 are shown symmetrically between top dead center and bottom dead center in the clockwise direction. This local coordinate system serves to describe the position of secondary conrod 46 relative to secondary shaft 44 and has its origin on the axis of secondary shaft 44.

From the combination of FIGS. 3b and 4b, it can be seen that the essential difference between the two embodiments shown therein lies in the fact that the rotational angle γ of secondary shaft 44 in FIG. 3b is symmetric to the 21:00 o'clock position, whereas the rotational angle γ of the secondary shaft in the embodiment according to FIG. 4b is symmetric to top dead center. The consequences of the various arrangements of the third rotational angle γ can be derived in general from the description of FIG. 5.

Because of the torque required on secondary shaft 44 to move needle beam arrangement 10, it can also be desirable to provide a second secondary drive 42 to move secondary shaft 44. It is also conceivable that two secondary conrods could be provided, each of which connects secondary shaft 44 to needle beam arrangement 10 in articulated fashion.

The stroke of needle beam arrangement 10 in conveying direction F is preferably in the range of 0-25 mm, more preferably 1-15 mm, and even more preferably 2-8 mm. The length of the stroke both in punching direction E and in conveying direction F, however, can also be adapted to the specific requirements, specifically to the thickness of the nonwoven web and to the conveying speed of the nonwoven web, and thus depart from the ranges indicated above. The stroke can be adjusted by changing the size of the predetermined rotational angle of the shaft and by changing the arrangement of the rotational angle relative to the rotational axis of the corresponding shaft. The frequency in conveying direction F is also preferably in the range of 1,500-3,000 strokes/minute.

For the person skilled in the art, it is clear that the invention is not limited to which of the shafts, i.e., first and second main shafts 24, 30 and secondary shaft 40, is moved cyclically back and forth or by what rotational angle such movement occurs. Instead, the inventive idea consists in moving at least one shaft, which uses a conrod supported eccentrically on it to cause a needle beam arrangement of a needle loom to execute stroke movements, cyclically back and forth instead of driving it continuously in rotation. In this way, the control unit of the needle loom can be used to vary the stroke of the needle beam arrangement in the punching direction E and/or in the conveying direction F in an especially easy manner by changing the rotational angle of one of the driven shafts.

The relationship between the rotational angle of a shaft on which a conrod is eccentrically supported and the resulting stroke of the needle beam arrangement is described in general terms with reference to FIGS. 5a and 5b. The statements made here pertain both to main shafts 24, 30 and to secondary shaft 44. For this purpose, the coordinate systems shown in FIGS. 5a and 5b are to be oriented in the same way as the systems shown in FIGS. 2, 3, and 4. When, therefore, a stroke is being discussed in reference to FIGS. 5a and 5b, what is involved when main shafts 24, 30 are being considered is a stroke in punching direction E, i.e., a vertical stroke, whereas, what is involved when secondary shaft 44 is being considered is a horizontal stroke, i.e., a stroke in conveying direction F.

Each of FIGS. 5a and 5b shows a local coordinate system of a shaft 24, 30, 44 and, in the form of a graph, the change in the length of the stroke versus the rotational angle. A first reversal point is designated “A”, and a second reversal point is designated “B”. The predetermined rotational angle is designated δ, and it is defined between first and second reversal points A, B. Rotational angle δ can be the same as first rotational angle α, the same as second rotational angle β, or the same as third rotational angle γ. The radius of the illustrated circle corresponds to the eccentricity of the conrod to the shaft, i.e., to the distance between the axis of the conrod eye and the rotational axis of the shaft. The origin of the illustrated coordinate system is arranged on the rotational axis of the shaft in question.

In FIG. 5a, rotational angle δ is symmetrically arranged between top dead center (OT) and bottom dead center (UT), that is, symmetrically to the 15:00 o'clock position. The same would apply to a symmetrical arrangement with respect to the 21:00 o'clock position. The movement of the conrod and of the shaft occurs around the rotational angle δ between first reversal point A and second reversal point B. The shaft is moved cyclically back and forth by the drive assigned to it between first reversal point A and second reversal point B.

In the case illustrated here, reversal point A forms the starting position, which represents the position of the conrod at minimum stroke. Relative to rotational angle δ, no stroke has occurred in this starting position. Moving the shaft and the conrod out of the starting position (reversal point A) toward second reversal point B has the effect of causing the needle beam arrangement to execute a stroke which is substantially parallel to the axis connecting top dead center and bottom dead center. The maximum stroke, here H1, is reached when the shaft and the conrod arrive at second reversal point B. At this point, the drive assigned to the shaft reverses the rotational direction of the shaft, so that the shaft and the conrod move back toward first reversal point A. At point A, the point of minimum stroke is reached again. If rotational angle δ is therefore between top dead center and bottom dead center, the movement of the shaft and of the conrod from first reversal point A to second reversal point B and back again causes needle beam arrangement 10 to execute a stroke equal to H1. It can be seen that, in the case of a symmetrical arrangement of rotational angle δ between top dead center and bottom dead center, a smaller rotational angle leads to a shorter stroke and a larger rotational angle leads to a longer stroke.

In contrast to that, rotational angle δ in FIG. 5b is arranged symmetrically to top dead center, i.e., symmetrically between the 21:00 o'clock position and the 15:00 o'clock position. The same would be true for a symmetrical arrangement around bottom dead center. The first reversal point A is located in this case between the 21:00 o'clock position and top dead center, and second reversal point B is located between top dead center and the 15:00 o'clock position. When the shaft and the conrod are now moved from the starting position (reversal point A) toward second reversal point B, a stroke movement takes place until top dead center is reached. At top dead center, the point of maximum stroke, here H2, is reached. When the shaft and the conrod are moved farther onward from top dead center to the second reversal point B, the length of the stroke decreases again. Therefore, first and second reversal points A, B are the points of minimum stroke, whereas maximum stroke H2 is reached at top dead center. At reversal point B, the drive assigned to the shaft reverses the rotational direction of the shaft, so that the shaft and the conrod move back toward first reversal point A. A new stroke movement thus takes place. Accordingly, the movement of the shaft and of the conrod from first reversal point A to second reversal point B and back again causes needle beam arrangement 10 two execute two stroke movements.

As can be seen from the combination of FIGS. 5a and 5b, for rotational angles δ of the same size, the length of the stroke to be reached when the rotational angle is arranged between top dead center and bottom dead center is much greater than when the rotational angle is arranged symmetrically to top dead center or bottom dead center. Conversely, when, for the same rotational speed of the shaft, the rotational angle is arranged symmetrically around top dead center or bottom dead center, the stroke frequency is doubled in comparison to that obtained when the rotational angle is arranged symmetrically to the 15:00 o'clock or 21:00 o'clock position.

The person skilled in the art will therefore realize that he has an enormous variety of possible ways to adjust the stroke of needle beam arrangement 10. It is obvious that the size of the rotational angle and the arrangement of that angle relative to top dead center or bottom dead center is subject theoretically to no limits. The variety of possible movements of needle beam arrangement 10 which can be produced can also be increased by providing each of the shafts, i.e., the first and second main shafts and the secondary shaft, with its own drive to move the shaft back and forth. In this way, each shaft can rotate at its own speed and have its own rotational angle, and its conrod can produce its own stroke. The main and secondary shafts, furthermore, can move in phase, in which case the points of maximum and minimum stroke are achieved simultaneously, or alternatively they can move out of phase.

The length of the stroke always has an effect on the torque to be applied to the associated shaft. A stroke movement of considerable length requires a large amount of torque, whereas a stroke movement of shorter length requires less torque. Accordingly, because of the shorter stroke movement upon arrangement of the rotational angle symmetrically to top dead center or bottom dead center, either the drive of the shaft can have smaller dimensions or the rotational speed can be increased.

When one now considers drive device 20 for moving needle beam arrangement 10 in punching direction E and secondary drive device 40 for moving needle beam arrangement 10 in conveying direction F, it can be seen that a stroke in punching direction E should usually take place simultaneously with a stroke in conveying direction F. If the stroke movement in punching direction E is produced by, for example, the movement of the at least one main shaft 24 around a rotational angle arranged between top dead center and bottom dead center (as in FIG. 5a), and the stroke in conveying direction F is produced by movement of secondary shaft 44 around a rotational angle symmetrical to top dead center or bottom dead center (compare FIG. 5b), the result is that secondary shaft 44 or the secondary drive 42 can be driven at half the frequency of drive device 20. Therefore, what is obtained for secondary drive 42 and for the components assigned to it is a lower rotational speed and thus, slower accelerations on the associated components (secondary drive 42, secondary shaft 44, secondary conrod 46). Lower accelerations have a wear-reducing effect on the components in question. In addition, the decreased accelerations also reduce the forces acting in conveying direction F of the needle loom, which can in turn cause unwanted vibrations.

Overall, the needle loom according to the invention provides a needle loom which, although of simple mechanical realization, makes possible a large number of possible ways to influence the stroke movements of the needle beam arrangement in the punching and conveying directions.

A wide variety of materials are available for the various parts discussed and illustrated herein. While the principals of this device have been described in connection with specific embodiments, it should be understood clearly that these descriptions are made only by way of example and are not intended to limit the scope of the device.

1. A needle loom for needling a nonwoven web comprising:
a needle beam arrangement, which comprises at least one needle beam, and
a drive device for moving the needle beam arrangement back and forth in a punching direction;
wherein the drive device comprises a first drive and a first main shaft, wherein a first main conrod, which connects the first main shaft to the needle beam arrangement in articulated fashion, is eccentrically supported on the first main shaft;
wherein the first drive is actuated in such a way that it moves the first main shaft cyclically back and forth around a predetermined first rotational angle.

2. The needle loom of claim 1 wherein the first rotational angle is in the range of 2-178°.

3. The needle loom of claim 2 wherein the first rotational angle is in the range of 10-90°.

4. The needle loom of claim 1 wherein the drive device also comprises a second drive and a second main shaft, wherein a second main conrod, which connects the second main shaft to the needle beam arrangement in articulated fashion, is supported eccentrically on the second main shaft, and wherein the second drive is actuated in such a way that it moves the second main shaft cyclically back and forth around a predetermined second rotational angle, wherein the second rotational angle is in the range of 2-178°.

5. The needle loom of claim 4 wherein the second rotational angle is in the range of 10-90°.

6. The needle loom of claim 4 wherein the first drive and the second drive are actuated in such a way that the first rotational angle is equal to the second rotational angle, and the first and the second main shafts are moved around angles of equal size at the same times.

7. The needle loom of claim 6 wherein the first drive and the second drive are actuated in such a way that they move the first and the second main shafts back and forth in opposite directions.

8. The needle loom of claim 4 wherein the first drive and the second drive are actuated in such a way that the first and second main shafts are moved out of phase with each other.

9. The needle loom according to claim 4 wherein the first drive and the second drive are actuated in such a way that the first rotational angle is not equal to the second rotational angle.

10. The needle loom of claim 1 wherein the first drive comprises a torque motor or a servo motor.

11. The needle loom of claim 4 wherein the second drive comprises a torque motor or a servo motor.

12. The needle loom according to claim 1 wherein the needle loom also comprises a secondary drive device for moving the needle beam arrangement in a conveying direction of the nonwoven web which is transverse to the punching direction, wherein the secondary drive device comprises a secondary drive and a secondary shaft, wherein a secondary conrod, which connects the secondary shaft to the needle beam arrangement in articulated fashion, is supported eccentrically on the secondary shaft,
wherein the secondary drive is actuated in such a way that it moves the secondary shaft cyclically back and forth around a predetermined third rotational angle.

13. A needle loom for needling a nonwoven web comprising:
a needle beam arrangement comprising at least one needle beam, a drive device for moving the needle beam arrangement back and forth in a punching direction, and a secondary drive device for moving the needle beam arrangement in a conveying direction of the nonwoven web which is transverse to the punching direction;
wherein the drive device comprises a first drive and a first main shaft, wherein a first main conrod, which connects the main shaft to the needle beam arrangement in articulated fashion, is supported eccentrically on the first main shaft;
wherein the secondary drive device comprises a secondary drive and a secondary shaft, wherein a secondary conrod, which connects the secondary shaft to the needle beam arrangement in articulated fashion, is supported eccentrically on the secondary shaft;
wherein the secondary drive is actuated in such a way that it moves the secondary shaft cyclically back and forth around a predetermined rotational angle.

14. The needle loom of claim 13 wherein the rotational angle is continuously variable.

15. The needle loom of claim 13 wherein the rotational angle is in the range of 2-178°.

16. The needle loom of claim 15 wherein the rotational angle is in the range of 10-150°.

17. The needle loom of claim 13 wherein the first drive is actuated in such a way that it moves the first main shaft continuously in rotation.

18. The needle loom of claim 13 wherein the secondary drive comprises a torque motor or a servo motor.
